(19) United States
(12) Patent Application Publication
(10) Pub. No.: US 2012/0147887 A1
(43) Pub. Date: Jun. 14, 2012

(54) METHOD AND DEVICE FOR DELIVERING AND RECEIVING PUSH MESSAGE

(75) Inventors: Shunan FAN, Beijing (CN); Jian YANG, Beijing (CN); Lei WANG, Beijing (CN)

(73) Assignee: Huawei Device Co., Ltd., Shenzhen (CN)

(21) Appl. No.: 13/404,910

(22) Filed: Feb. 24, 2012

Related U.S. Application Data
(63) Continuation of application No. PCT/CN2010/076251, filed on Aug. 23, 2010.

(30) Foreign Application Priority Data
Aug. 24, 2009 (CN) 200910163085.4

(51) Int. Cl. H04L 12/56

(52) U.S. Cl. 370/390

(57) ABSTRACT

A method and a device for delivering and receiving a Push message are provided, so that a Push server knows the delivery state of the Push message when delivering the Push message in a broadcast mode or a multicast mode. The method includes: a Push server receives a Push message that carries an indication of making statistics on a delivery result; and the Push server determines to deliver the Push message to terminals in a broadcast mode or a multicast mode according to the Push message, and obtains a delivery report according to the indication of making statistics on the delivery result. A method for obtaining the delivery report by the Push server includes obtaining the delivery report by querying a group management server, or obtaining the delivery report by receiving responses returned by the terminals, or obtaining the delivery report by querying the number of connections between the term.

### CROSS-REFERENCE TO RELATED APPLICATIONS

This application is a continuation of international Application No. PCT/CN2010/076251, filed on Aug. 23, 2010, which claims priority to Chinese Patent Application No. 200910163085.4, filed on Aug. 24, 2009, both of which are hereby incorporated by reference in their entireties.

### FIELD OF THE INVENTION

The present invention relates to the field of communications technologies, and in particular, to a method and a device for delivering and receiving a Push message.

### BACKGROUND OF THE INVENTION

Push is a content distribution mechanism, and works in a client/server mode. A Push Initiator (PI) pushes information and a delivery instruction to a Push server without being requested by a client, and then the Push server sends the Push content to a terminal according to the delivery instruction. The Push server obtains a message from the PI through a Push Access Protocol (PAP), and then sends the content to the terminal through a Push Over The Air (OTA) protocol.

The Push message may be sent in a point-to-point or point-to-multipoint mode. In the process of sending a Push message in a point-to-point mode, the terminal may return an Acknowledge (ACK) message to the Push server as an indication of having received the Push message. The Push server returns a delivery report to the PI according to the ACK message. If the Push message is directed to multiple terminals, if the message is still sent in a point-to-point mode, the Push server needs to send the same Push message repeatedly, resulting in the increase of the load on the bearer network. Therefore, the point-to-multipoint mode is preferred for sending a Push message to multiple terminals.

During the implementation of the present invention, the inventors find that, in the process of sending a Push message in a point-to-multipoint mode, if the Push server delivers the Push message in a broadcast mode or a multicast mode, because the destination terminals are not known before delivery of the Push message, or because the terminals have no uplink channel available for returning a receiving response, the Push server cannot know the delivery state of the Push message.

### SUMMARY OF THE INVENTION

The embodiments of the present invention provide a method and a device for delivering and receiving a Push message, so that the Push server knows the delivery state of the Push message when delivering the Push message in a broadcast mode or a multicast mode.

A method for delivering a Push message according to an embodiment of the present invention includes:

receiving a Push message, in which the Push message carries an indication of making statistics on a delivery result;

determining to deliver the Push message to terminals in a broadcast mode or a multicast mode according to the Push message; and

obtaining a delivery report according to the indication of making statistics on the delivery result.

A method for receiving a Push message according to a n embodiment of the present invention includes:

receiving a Push message delivered by a Push server in a broadcast mode or a multicast mode, in which the Push message carries an indication of returning a receiving response; and

returning a receiving response to the Push server or setting up a connection to the Push server according to the indication of returning the receiving response.

Corresponding to the method described above, an embodiment of the present invention provides a Push server, where the Push server includes:

a receiving unit, configured to receive a Push message, in which the Push message carries an indication of making statistics on a delivery result;

a delivery mode determination unit, configured to determine to deliver the Push message to terminals in a broadcast mode or a multicast mode according to the Push message; and

a delivery report obtaining unit, configured to obtain a delivery report according to the indication of making statistics on the delivery result.

A terminal is further provided, where the terminal includes:

a receiving unit, configured to receive a Push message delivered by a Push server in a broadcast mode or a multicast mode, in which the Push message carries an indication of returning a receiving response; and

a response returning unit, configured to return the receiving response to the Push server or set up a connection to the Push server according to the indication of returning the receiving response.

According to the technical solutions according to the embodiments of the present invention, when the Push server delivers a Push message to the terminals in a broadcast mode or a multicast mode, the PI adds an indication of making statistics on the delivery result into the Push message, and the Push server obtains a delivery report according to the indication. Therefore, the Push server can know the delivery state of the Push message when delivering the Push message in a broadcast mode or a multicast mode.

### BRIEF DESCRIPTION OF THE DRAWINGS

To make the technical solutions of the present invention clearer, the accompanying drawings for illustrating the embodiments of the present invention are outlined below.

FIG. 1 is a flow chart of a method for delivering a Push message according to an embodiment of the present invention;

FIG. 2 is a flow chart of a method for receiving a Push message according to an embodiment of the present invention;

FIG. 3 is a first functional composition diagram of a Push server according to an embodiment of the present invention;

FIG. 4 is a second functional composition diagram of a Push server according to an embodiment of the present invention;

FIG. 5 is a first functional composition diagram of a terminal according to an embodiment of the present invention;

FIG. 6 is a second functional composition diagram of a terminal according to an embodiment of the present invention;

FIG. 7 is a composition diagram of a system for delivering a Push message according to an embodiment of the present invention; and

FIG. 8 is a specific flow chart of implementing a method embodiment according to the present invention.

### DETAILED DESCRIPTION OF THE EMBODIMENTS

The technical solutions according to the embodiments of the present invention are detailed below with reference to accompanying drawings.

### Embodiment 1

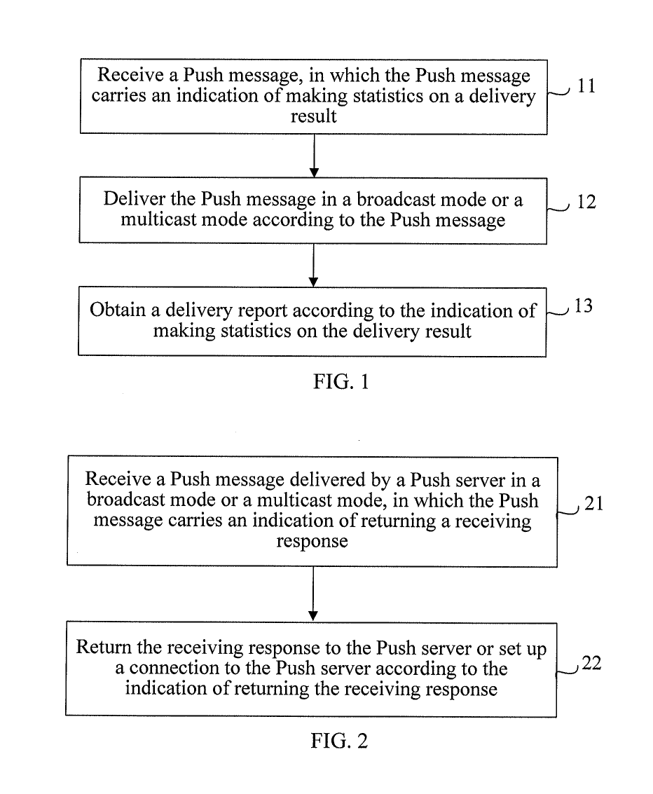

Referring to FIG. 1, a method for delivering a Push message according to the embodiment of the present invention includes:

Step 11: Receive a Push message, in which the Push message carries an indication of making statistics on a delivery result.

The Push server receives the Push message, in which Push message carries an indication of making statistics on a delivery result. The indication of making statistics on the delivery result is carried in the Push message, for example, in a parameter of the Push message. In the following example, the indication is carried in a Quality of Service (QoS) parameter:

<!ELEMENT Push-message ( address+, quality-of-service? ) >
<!ATTLIST Push-message

| | | |
|---|---|---|
| Push-id | CDATA | #REQUIRED |

| | | |
|---|---|---|
| replace-Push-id | CDATA | #IMPLIED |

| | |
|---|---|
| replace-method | ( pending-only |

| | |
|---|---|
| \| all ) | “all” |

| | | |
|---|---|---|
| deliver-before-timestamp | %Datetime; | #IMPLIED |
| deliver-after-timestamp | %Datetime; | #IMPLIED |

| | | |
|---|---|---|
| source-reference | CDATA | #IMPLIED |

| | | |
|---|---|---|
| Push server-notify-requested-to | CDATA | #IMPLIED |

| | |
|---|---|
| progress-notes-requested | ( true \| false ) “false” |

>
<!ELEMENT address EMPTY >
<!ATTLIST address

| | | |
|---|---|---|
| address-value | CDATA | #REQUIRED |

>A broadcast mode or a multicast mode is indicated here for delivering the Push message
according to the address type
<!ELEMENT quality-of-service EMPTY >
<!ATTLIST quality-of-service

| | | |
|---|---|---|
| priority | ( high \| medium \| low ) | “medium” |

| | |
|---|---|
| delivery-method | ( confirmed \| preferconfirmed |

```
  | confirmed-with-response
  | oneshot
| unconfirmed | notspecified ) “notspecified”
```

| | | |
|---|---|---|
| Deliver-Report | CDATA | #IMPLIED An |

identifier is added to indicate that the Push server should make statistics on the delivery
result, and the type of the delivery report may be indicated in the Deliver-Report value, for
example, delivery-number indicates that the Push server should make statistics on the number
of destination terminals of the Push message.

| | | |
|---|---|---|
| network | CDATA | #IMPLIED |

| | | |
|---|---|---|
| network-required | ( true \| false ) | “false” |

| | | |
|---|---|---|
| bearer | CDATA | #IMPLIED |

| | | |
|---|---|---|
| bearer-required | ( true \| false ) | “false” |

>

The following gives a possible metadata format of a Delivery-Report:

| Information | | |
|---|---|---|
| Element | Type | Value |
| Push ID | String | Identifier of a Push message |
| Receiver-Address | String | Broadcast or multicast address type |
| Sender-Address | String | Address to which the delivery report is returned |
| Deliver-Report | String list | Instruct the Push server to make statistics on the |
| | | corresponding delivery result |
| Deliver-Report | String list | Value of the delivery report type. For example, |
| Values | | “delivery-number” is an indication of making |
| | | statistics on the number of destination terminals of |
| | | the Push message; “successful-number” is an |
| | | indication of making statistics on the number of |
| | | terminals that receive the Push message successfully; |
| | | “unsuccessful-number” is an indication of making |
| | | statistics on the number of terminals that fail to |
| | | receive the Push message; and “rejected-number” is |
| | | an indication of making statistics on the number of |
| | | terminals that reject to receive the Push message |

The Push server judges the type of the delivery result for statistics according to the Delivery-Report indication information in the Push message.

In this embodiment of the present invention, the Push server may be a Push Proxy Gateway (PPG) in a point-to-multipoint message system. The Push message is sent by the PI to the PPG, and the indication of making statistics on the delivery result may be information for requesting a result notification carried in the Push message sent by the PT to the PPG.

Step 12: Deliver the Push message in a broadcast mode or a multicast mode according to the Push message.

The Push server determines to deliver the Push message in a broadcast mode or a multicast mode according to the Push message. For example, the PI may use the address type in the instruction to instruct the Push server to send the Push message in a broadcast mode or a multicast mode; or the Push server judges whether to send the Push message in a broadcast mode or a multicast mode.

Step 13: Obtain a delivery report according to the indication of making statistics on the delivery result.

The Push server obtains a delivery report according to the indication of making statistics on the delivery result. Specifically, the Push server obtains the delivery reports of all delivery result types, or obtains the delivery reports of only the indicated delivery result type.

The Push server obtains the delivery report by querying a group management server, or by receiving the receiving responses returned by the terminals, or by querying the number of connections between the terminals and the server.

For example, if the PI instructs the Push server to send the Push message in a multicast mode, the Push server may obtain the number of the destination terminals of the Push message by querying the group that includes the destination terminals. When the Push server obtains the delivery report by querying the group management server, the Push server may obtain the address information of the destination terminals before sending the Push message, and obtain the number of destination terminals of the Push message; moreover, the Push server may obtain the number of actually delivered Push messages according to the number of sent Push messages or the number of Push messages sent by the bearer network; and may obtain the number of successfully received Push messages by receiving the receiving responses returned by the terminals or by setting up a connection to the terminal. Nevertheless, the Push server may query the bearer network server to obtain the number of users in the multicast group before sending the Push message; or make statistics on the number of terminals that receive the Push message according to the distributed keys, access parameters, subscription process, service declaration, and the number of messages returned as a confirmation of joining the group.

The terminal judges whether the Push message delivered by the Push server carries an indication of returning a receiving response, and returns a receiving response to the Push server if the Push message carries the indication. The types of the receiving response include: receiving success response, receiving failure response, receiving rejection response, pending response, and re-delivery-disabled response.

The Push server can make statistics on the delivery reports of the Push message according to the result obtained by querying the group management server, or the receiving responses returned by the terminals, or the connection set up between the server and the terminals. For the same Push message identifier, the statistical number is stored in categories, for example, the number of successfully sent Push messages and the number of unsuccessfully sent Push messages are stored respectively.

The Push server may return a delivery report to the PI proactively or according to a message for requesting a delivery report sent by the PI. The returned delivery reports include delivery reports of all delivery result types and delivery reports of only the requested delivery result type. Alternatively, according to a request message for querying a certain type of delivery report from another server, the Push server may also determine whether to return the requested result to the other server according to the returning policy, and return available query results to the other server if the Push server determines to return the requested result.

If the Push message is delivered to the terminals in a broadcast mode or a multicast mode, and the Push message carries an indication of returning a receiving response, but the terminals have no uplink channel for returning the receiving response, the Push server may add an indication of a bearer mode into the Push message delivered to the terminals, so that the terminals return receiving responses in the indicated bearer mode.

One or more bearer modes may be indicated, and the terminal determines and selects one of the indicated bearer modes for returning a receiving response. The indication information may be carried in the Push message sent to the terminal, for example, in a QoS parameter; or the message header field, value range or message body of the Push message is extended to carry an identifier of the bearer mode used by the terminal for returning the receiving response. The Push message may further specify receiver address information of the receiving response and/or an identifier of the Push message. For example, the Push message indicates that the receiving response should be returned through an SMS, Email, HTTP, WSP, or SIP signaling. The terminal resolves the identifier indicating the bearer mode and activates a corresponding application, and returns a receiving response in the indicated bearer mode. In this way, it is ensured that the terminals return receiving responses even if no uplink channel is available. Here is an example:

| Information Element | Type | Value |
|---|---|---|
| Push ID | String | Identifier of a Push message |
| Receiver-Address | String | Broadcast or multicast address type |
| Sender-Address | String | Address to which the receiving response will be |
| | | returned |
| Report-Return-Method | String | Bearer mode used by the terminal, namely, returning |
| | list | the receiving response through an SMS, Email, HTTP, |
| | | WSP, or SIP signaling |

Nevertheless, if the Push message delivered to the terminals does not indicate the bearer mode, the terminal may return a receiving response in a default mode.

To enhance the statistical function of the Push server, the PI may add an indication of a statistical mode into the Push message, so that the Push server makes statistics on the delivery report in the statistical mode indicated in the Push message. The Push server returns the statistical result to the PI by extending the message header field, value range or message body of the delivery report. In this way, the PI can receive delivery results of detailed types, which helps the user to enjoy better experience.

The statistical result may be carried in the message header of the delivery report. For example, the message header of the delivery report returned by the Push server to the PI carries the following statistical result:

<!ELEMENT resultnotification-message ( address, quality-of-service? ) >
<!ATTLIST resultnotification-message

| | | |
|---|---|---|
| Push-id | CDATA | #REQUIRED |

| | | |
|---|---|---|
| Number | CDATA | #IMPLIED |

(if this Push message is delivered in a multicast mode, the specific number
of destination terminals may be specified)

| | | |
|---|---|---|
| Successful-number | CDATA | #REQUIRED |

(statistical number of successfully received messages)

| | | |
|---|---|---|
| sender-address | CDATA | #IMPLIED |

| | | |
|---|---|---|
| sender-name | CDATA | #IMPLIED |

| | | |
|---|---|---|
| received-time | %Datetime; | #IMPLIED |
| event-time | %Datetime; | #IMPLIED |
| message-state | %State; | #REQUIRED |

| | | |
|---|---|---|
| code | CDATA | #REQUIRED |

| | | |
|---|---|---|
| desc | CDATA | #IMPLIED |

“Number” is the number of terminals to which the Push message is sent, or the number of terminals that return a receiving response. “Successful-Number” is the number of terminals that receive the Push message successfully. Additionally, “Rejected-Number” indicates the number of terminals that reject to receive the Push message; “Pending-Number” indicates the number of terminals that are processing the Push message currently; and “Undeliverable Number” indicates the number of terminals to which the Push message is not delivered.

```
  <!ELEMENT resultnotification-message ( address, quality-of-service? ) >
  <!ATTLIST resultnotification-message
```

| | | |
|---|---|---|
| Push-id | CDATA | #REQUIRED/#IMPLIED) |
| sender-address | CDATA | #IMPLIED |

| | | |
|---|---|---|
| sender-name | CDATA | #IMPLIED |

| | | |
|---|---|---|
| received-time | %Datetime; | #IMPLIED |
| event-time | %Datetime; | #IMPLIED |
| message-state | %State; | #REQUIRED |

| | | |
|---|---|---|
| message-state-number | CDATA | #REQUIRED |

| | | |
|---|---|---|
| code | CDATA | #REQUIRED |
| desc | CDATA | #IMPLIED |

>The Message-state=%state specifies the result of processing the message:
For example, if Message-state=rejected is followed by n=15, it indicates that 15 Push
messages are rejected; and
if Message-state=delivered is followed by n=100, it indicates that 100 Push messages are
received successfully
...

Nevertheless, the Push server may add the statistical result into the message body of the Push message, and return the message in the following mode:

| Report State | Number | Address Information |
|---|---|---|
| Successful-Number | n | Address Info |
| Rejected-Number | n | Address Info |
| Pending-Number | n | Address Info |
| Undeliverable-Number | n | Address Info |
| Delivered-Number | n | Address Info |
| Expired-Number | n | Address Info |
| Aborted-Number | n | Address Info |
| Timeout-Number | n | Address Info |
| Cancelled-Number | n | Address Info |
| Unknown-Number | n | Address Info |
| Total-report-Number | n | Address Info |

Optionally, the PI returns a receiving response to the Push server upon receiving the delivery report.

Additionally, after a terminal receives a Push message that carries an indication of returning a receiving response, if the terminal returns no receiving response or returns a delivery failure response, the Push server may optionally report the address information of the terminal to the PI. According to the address information of the terminal, the PI determines whether to instruct the Push server to re-deliver the Push message to the terminal that does not successfully receive the Push message in a unicast, multicast or broadcast mode, or the Push server itself determines whether to re-deliver the Push message in a unicast, multicast or broadcast mode according to the address information of the terminal, thereby improving the success rate of delivery.

In the method for delivering a Push message according to the embodiment of the present invention, when the Push server delivers a Push message to the terminals in a broadcast mode or a multicast mode, the PI adds an indication of making statistics on the delivery result into the Push message, so that the Push server obtains delivery reports according to the indication, and knows the delivery state of the Push message when delivering the Push message in a broadcast mode or a multicast mode.

### Embodiment 2

Referring to FIG. 2, a method for receiving a Push message according to the embodiment of the present invention includes:

Step 21: Receive a Push message delivered by a Push server in a broadcast mode or a multicast mode, in which the Push message carries an indication of returning a receiving response.

The terminal receives the Push message delivered by the Push server in a broadcast mode or a multicast mode. The Push message carries an indication of returning a receiving response. Specifically, the indication of returning the receiving response may be carried in a QoS parameter of the Push message. For example, a Response-Report identifier is added in the QoS parameter as an indication that the terminal needs to return a receiving response to the Push server.

Step 22: Return a receiving response to the Push server or set up a connection to the Push server according to the indication of returning the receiving response.

The terminal receives the Push message, and judges whether the Push message carries an indication of returning a receiving response, and returns a receiving response to the Push server if the Push message carries the indication. The types of the receiving response include: receiving success response, receiving failure response, receiving rejection response, pending response, and re-delivery-disabled response. The Push server makes statistics on the delivery reports of the Push message according to the receiving responses returned by the terminals, or the connection set up between the server and the terminals, so that the Push server can know the delivery state of the Push message even if the Push message is delivered in a broadcast mode or a multicast mode.

If the Push message is delivered to the terminals in a broadcast mode or a multicast mode, and the Push message carries an indication of returning a receiving response, but the terminals have no uplink channel for returning the receiving response, the Push server may add an indication of a bearer mode into the Push message delivered to the terminals, so that the terminal activates a corresponding application according to the indication of the bearer mode, and returns a receiving response to the Push server in the indicated bearer mode.

One or more bearer modes may be indicated, and the terminal determines and selects one of the indicated bearer modes for returning a receiving response. The indication information may be carried in the Push message sent to the terminal, for example, in a QoS parameter; or the message header field, value range or message body of the Push message is extended to carry an identifier of the bearer mode used by the terminal for returning the receiving response. The Push message may further specify receiver address information of the receiving response and/or an identifier of the Push message. For example, the Push message indicates that the receiving response should be returned through an SMS, Email, HTTP, WSP, or SIP signaling. The terminal resolves the identifier indicating the bearer mode and activates a corresponding application, and returns a receiving response in the indicated bearer mode. In this way, it is ensured that the terminals return receiving responses even if no uplink channel is available. Nevertheless, if the Push message does not indicate the bearer mode, the terminal may return a receiving response in a default mode.

In the method for receiving a Push message according to the embodiment of the present invention, when the Push server delivers a Push message to the terminals in a broadcast mode or a multicast mode, and the Push message carries an indication of returning a receiving response, so that the terminals return receiving responses after receiving the message, and the Push server can make statistics on the delivery reports of the Push message according to the receiving response or the connection set up between the terminals and the server.

### Embodiment 3

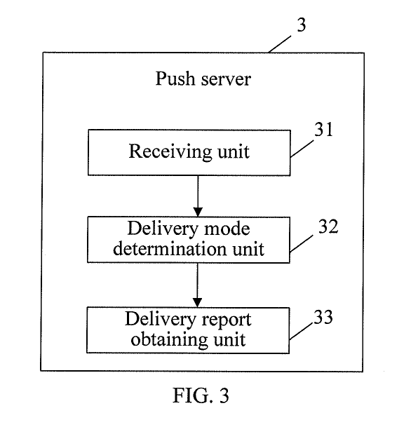

Referring to FIG. 3, a Push server according to the embodiment of the present invention includes:

a receiving unit 31, configured to receive a Push message, in which the Push message carries an indication of making statistics on a delivery result;

a delivery mode determination unit 32, configured to determine to deliver the Push message to terminals in a broadcast mode or a multicast mode according to the Push message; and

a delivery report obtaining unit 33, configured to obtain a delivery report according to the indication of making statistics on the delivery result.

The obtaining the delivery report according to the indication of making statistics on the delivery result includes: obtaining delivery reports of all delivery result types, or obtaining delivery reports of only the indicated delivery result type.

The report obtaining unit 33 includes at least one of the following modules:

a first obtaining module, configured to obtain the delivery report by querying a group management server;

a second obtaining module, adapted to obtain the delivery report by receiving the receiving responses returned by the terminals; and

a third obtaining module, configured to obtain the delivery report by querying the number of connections set up between the terminals and the server.

The Push server may return a delivery report to the PI proactively or according to a message for requesting a delivery report sent by the PI. The returned delivery reports include delivery reports of all delivery result types and delivery reports of only the requested delivery result type. Alternatively, according to a request message for querying a certain type of delivery report from another server, the Push server may also determine whether to return the requested result to the other server according to the returning policy, and return available query results to the other server if the Push serve determines to return the requested result.

In the embodiment of the present invention, the Push server may be a PPG in a point-to-multipoint message system. The Push message received by the PPG is sent by the PI to the PPG.

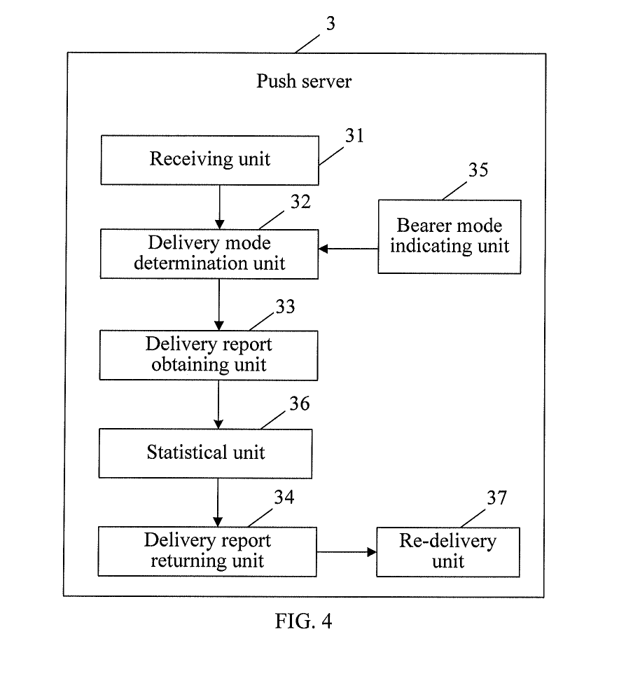

Therefore, referring to FIG. 4, the Push server 3 according to the embodiment of the present invention further includes a delivery report returning unit 34, which at least includes one of the following modules:

a proactive returning module, configured to return the delivery report to the PI proactively;

a request-based returning module, configured to return the delivery report to the PI according to a message for requesting a delivery report sent by the PI; and

a policy-based returning module, configured to determine whether to return the requested delivery report according to a returning policy if a server other than the PI sends a message for requesting the delivery report.

If the Push message is delivered to the terminals in a broadcast mode or a multicast mode, and the Push message carries an indication of returning a receiving response, but the terminals have no uplink channel for returning the receiving response, the Push server further includes:

a bearer mode indication unit 35, configured to add an indication of a bearer mode into the Push message delivered to the terminals, so that the terminal activates the corresponding application according to the indication of the bearer mode and returns a receiving response in the indicated bearer mode. Therefore, it is ensured that the terminals return receiving responses even if no uplink channel is available to the terminal.

To enhance the statistical function of the Push server, the PI may add an indication of a statistical mode of the delivery report into the Push message. Therefore, referring to FIG. 4, the Push server further includes:

a statistical unit 36, configured to make statistics on the delivery reports in the statistical mode indicated in the Push message. In this case, the delivery report returning unit 34 is specifically configured to return the statistical result to the PI by extending the message header field, value range, or message body of the delivery report. In this way, the PI can receive specific types of delivery results, which improves experience of the user.

Moreover, after a terminal receives a Push message that carries an indication of returning a receiving response, if the terminal returns no receiving response or returns a delivery failure response, the Push server may re-deliver the Push message to the terminal according to the address information of the terminal, thereby improving the success rate of delivery. Accordingly, the Push server may further include:

a re-delivery unit 37, configured to re-deliver the Push message to the terminal according to the address information of the terminal if the Push message carries an indication of returning a receiving response but the terminal returns no receiving response or returns a delivery failure response.

The Push server according to the embodiment of the present invention is applicable to the first method embodiment above, so that the Push server can know the delivery state of the Push message even if the Push message is delivered in a broadcast mode or a multicast mode.

### Embodiment 4

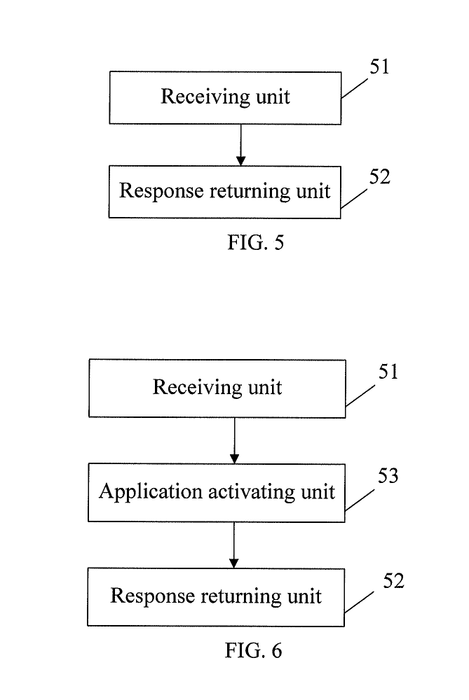

Referring to FIG. 5, a terminal provided according to the embodiment of the present invention includes:

a receiving unit 51, configured to receive a Push message delivered by a Push server in a broadcast mode or a multicast mode, in which the Push message carries an indication of returning a receiving response; and

a response returning unit 52, configured to return a receiving response to the Push server or set up a connection to the Push server according to the indication of returning the receiving response.

The receiving unit 51 of the terminal receives the Push message, and judges whether the Push message carries an indication of returning a receiving response, and returns a receiving response to the Push server if the Push message carries the indication. The types of the receiving response include: receiving success response, receiving failure response, receiving rejection response, pending response, and re-delivery-disabled response. The Push server makes statistics on the delivery reports of the Push message according to the receiving responses returned by the terminals, or the connection set up between the server and the terminals, so that the Push server can know the delivery state of the Push message even if the Push message is delivered in a broadcast mode or a multicast mode.

If the Push message is delivered to the terminals in a broadcast mode or a multicast mode, and the Push message carries an indication of returning a receiving response, but the terminals have no uplink channel for returning the receiving response, the Push server may add an indication of a bearer mode into the Push message delivered to the terminals, so that the terminal activates a corresponding application according to the indication of the bearer mode, and returns a receiving response to the Push server in the indicated bearer mode. In this way, it is ensured that the terminals return receiving responses even if no uplink channel is available to the terminal. Accordingly, referring to FIG. 6, the terminal according to the embodiment of the present invention further includes:

an application activating unit 53, configured to activate the corresponding application according to the bearer mode indicated in the Push message. In this case, the response returning unit 52 is specifically configured to return a receiving response to the Push server in the indicated bearer mode.

The terminal according to the embodiment of the present invention is applicable to the second method embodiment above, so that the Push server can know the delivery state of the Push message even if the Push message is delivered in a broadcast mode or a multicast mode.

### Embodiment 5

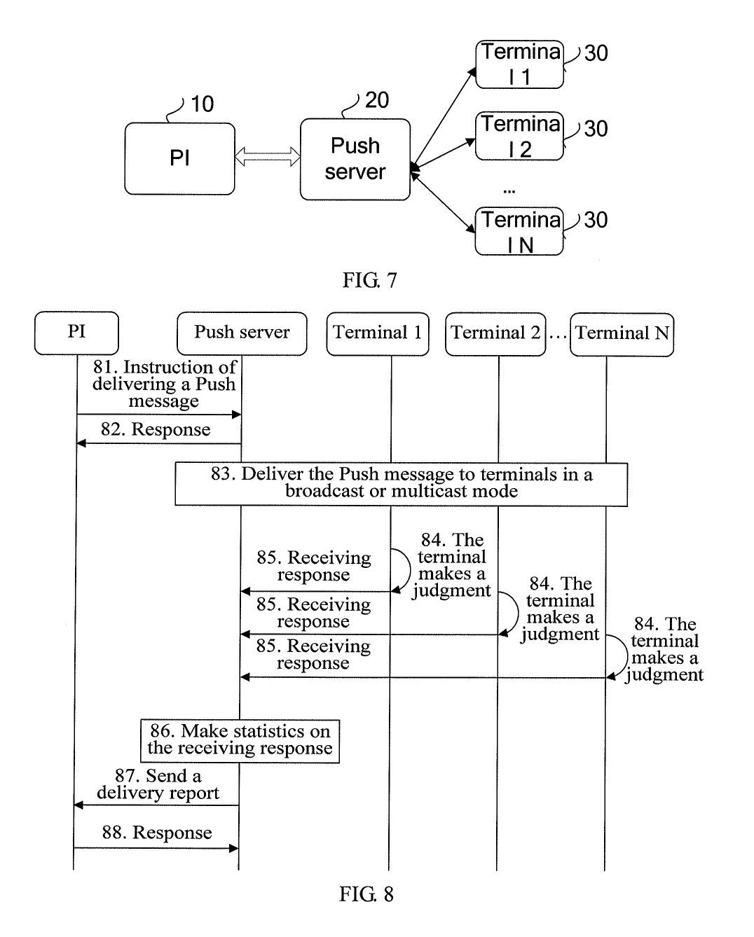

Referring to FIG. 7, a system for delivering a Push message according to the embodiment of the present invention includes a PI 10, a Push server, and several terminals 30.

The Push server 20 is configured to receive an instruction of delivering a Push message sent by the PI, in which the Push message that carries an indication of making statistics on the delivery result, determine to deliver the Push message to the terminals in a broadcast mode or a multicast mode according to the Push message, and obtain a delivery report according to the indication of making statistics on the delivery result.

Specifically, the Push server 20 is configured to obtain the delivery report by querying a group management server, or by receiving responses returned by the terminals, or by querying a number of connections set up between the terminals and the server. The obtaining the delivery report includes: obtaining delivery reports of all delivery result types, or obtaining delivery reports of only the indicated delivery result type.

The Push server 20 is further configured to return the delivery report to the PI proactively, or return the delivery report to the PI according to a massage for requesting the delivery report sent by the PI, or determine whether to return a response that carries the requested delivery report according to a returning policy if a server other than the PI requests to return the delivery request. The returning the delivery report includes: returning delivery reports of all delivery result types, or returning delivery reports of only the requested delivery result type.

If the terminals have no uplink channel available for returning the receiving response, the Push server 20 is further configured to add an indication of a bearer mode into the Push message delivered to the terminals, so that the terminal activates a corresponding application according to the indication of the bearer mode and returns a receiving response in the indicated bearer mode.

To enhance the statistical function of the Push server 20, the PI 10 adds an indication of a statistical mode into the Push message. In this case, the Push server is further configured to make statistics on the delivery report in the statistical mode indicated in the Push message, and return the statistical result to the PI by extending the message header field, value range, or message body of the delivery report.

FIG. 8 is a specific flow chart of implementing a method embodiment according to the present invention. The method includes the following steps.

Step 81: By sending an instruction of delivering a Push message to the Push server, the PI instructs the Push server to deliver the Push message in a broadcast mode or a multicast mode.

The Push message carries an indication of making statistics on delivery reports, or an indication of a bearer mode of the terminal, or an indication of a statistical mode.

Step 82: The Push server returns a response message. This step is optional.

Step 83: The Push server delivers the Push message to terminals in a broadcast mode or a multicast mode.

Step 84: The terminal determines whether to return a receiving response after receiving the Push message, and optionally, judges whether the Push message indicates a bearer mode. If multiple bearer modes are indicated, the terminal activates the corresponding application according to the network conditions, user's favorites, setting and capability information, and selects a bearer mode for returning a receiving response.

Step 85: The terminals return receiving responses to the Push server in the indicated bearer mode or a default bearer mode.

Step 86: After receiving the receiving responses returned by the terminals, the Push server buffers the receiving response and makes classification and statistics, for example, makes statistics on the number of successfully sent Push messages and the number of unsuccessfully sent Push messages. If the Push message further carries an indication of statistical mode, the Push server makes statistics on the receiving responses returned by the terminals in the indicated statistical mode.

Step 87: The Push server sends a delivery report to the PI according to the statistical result. Because the terminals may receive the Push message at different time or return the receiving response at different time, the terminals may return delivery reports in batches, or receive all statistical results and return all delivery reports together, or send the delivery reports within a set time limit. The delivery report needs to specify the identifier of the Push message, so that the PI can identify the delivery report corresponding to which Push message according to the identifier.

Step 88: The PI returns a response message to the Push server after receiving the delivery report.

In this process, before the Push server returns a delivery report to the PI, the PI may add a query request additionally in any step to request the delivery state of the Push message.

Persons of ordinary skill in the art can further understand that, the units and the steps described herein may be implemented by electronic hardware, computer software, or a combination thereof. In order to illustrate the interchangeability of the hardware and the software, the composition and steps of the embodiments of the present invention are generically described according to functions in the above description. Whether the functions are implemented through hardware or software depends on the specific application of the technical solution and the constraint conditions of the design. Persons of ordinary skill in the art can use different methods to implement the described functions for each specific application, and such implementation shall not be construed as falling outside the scope of the embodiments of the present invention in any way.

The steps of the method described herein may be implemented through hardware and/or a software module executed by a processor. The software module may be located in a Random-access Memory (RAM), computer memory, Read-only Memory (ROM), electrically programmable ROM, electrically erasable programmable ROM, register, hard disk, moveable disk, CD-ROM, or any other storage media.

Although the invention has been described through some exemplary embodiments, the invention is not limited to such embodiments. It is apparent that any modification, equivalent replacement, and improvement made by persons of ordinary skill in the art without departing from the spirit of the present invention shall fall within the protection scope of protection.

1. A method for delivering a Push message, comprising:
receiving the Push messagethat carries an indication of making statistics on a delivery result;
determining to deliver the Push message to terminals in a broadcast mode or a multicast mode according to the Push message; and
obtaining a delivery report according to the indication of making statistics on the delivery result.

2. The method according to claim 1, wherein obtaining the delivery report according to the indication of making statistics on the delivery result comprises one of the following:
obtaining the delivery report by querying a group management server;
obtaining the delivery report by receiving responses returned by the terminals; and
obtaining the delivery report by querying a number of connections set up between the terminals and the server.

3. The method according to claim 2, wherein obtaining the delivery report by querying a group management server specifically comprises:
querying a number of destination terminals that receive the Push message, before sending the Push message.

4. The method according to claim 1, further comprising:
returning the delivery report to a Push Initiator (PI) proactively; or
returning the delivery report to the PI according to a message for requesting the delivery report sent by the PI; or
determining whether to return a requested delivery report according to a returning policy if a server other than the PI sends a message for requesting the delivery report.

5. The method according to claim 1, wherein:
the obtaining the delivery report according to the indication of making statistics on the delivery result comprises: obtaining delivery reports of all delivery result types, or obtaining delivery reports of only an indicated delivery result type.

6. The method according to claim 4, wherein if the terminals have no uplink channel available for returning the receiving response, the method further comprises:
adding an indication of a bearer mode into the Push message delivered to the terminals, so that the terminal activates a corresponding application according to the indication of the bearer mode and returns a receiving response in the indicated bearer mode.

7. The method according to claim 4, wherein the Push message further carries an indication of a statistical mode, and the method further comprises:
making statistics on the delivery report in the indicated statistical mode, and returning a statistical result to the PI by extending a message header field, a value range, or a message body of the delivery report.

8. The method according to claim 2, wherein if the Push message carries an indication of returning a receiving response but the terminal returns no receiving response or returns a delivery failure response, according to address information of the terminal, the Push message is redelivered to the terminals.

9. The method according to claim 1, wherein the indication of making statistics on the delivery result is information for requesting a result notification, carried in the Push message sent by the PI.

10. A Push server, comprising:
a receiving unit, configured to receive a Push message that carries an indication of making statistics on a delivery result;
a delivery mode determination unit, configured to determine to deliver the Push message to terminals in a broadcast mode or a multicast mode according to the Push message; and
a delivery report obtaining unit, configured to obtain a delivery report according to the indication of making statistics on the delivery result.

11. The Push server according to claim 10, wherein the delivery report obtaining unit comprises at least one of the following modules:
a first obtaining module, configured to obtain the delivery report by querying a group management server;
a second obtaining module, configured to obtain the delivery report by receiving responses returned by the terminals; and
a third obtaining module, configured to obtain the delivery report by querying a number of connections set up between the terminals and the server.

12. The Push server according to claim 10, further comprising a delivery report returning unit, wherein the delivery report returning unit comprises at least one of the following modules:
a proactive returning module, configured to return the delivery report to a Push Initiator (PI) proactively;
a request-based returning module, configured to return the delivery report to the PI according to a message for requesting the delivery report sent by the PI; and
a policy-based returning module, configured to determine whether to return a requested delivery report according to a returning policy if a server other than the PI sends a message for requesting the delivery report.

13. The Push server according to claim 12, further comprising:
a bearer mode indication unit, configured to add an indication of a bearer mode into the Push message delivered to the terminals, so that the terminal activates a corresponding application according to the indication of the bearer mode and returns a receiving response in the indicated bearer mode.

14. The Push server according to claim 12, further comprising:
a statistical unit, configured to make statistics on obtained delivery reports in a statistical mode indicated in the Push message;
wherein the delivery report returning unit is specifically configured to return a statistical result to the PI by extending a message header field, a value range, or a message body of the delivery report.

15. The Push server according to claim 11, further comprising:
a re-delivery unit, configured to re-deliver the Push message to the terminal according to address information of the terminal if the Push message carries an indication of returning a receiving response but the terminal returns no receiving response or returns a delivery failure response.

16. The Push server according to claim 10, wherein the Push server is a Push Proxy Gateway (PPG) in a point-to-multipoint message system.
